(19) United States
(12) Patent Application Publication
(10) Pub. No.: US 2020/0251243 A1
(43) Pub. Date: Aug. 6, 2020

(54) Magnet Wire With Improved Enamel Adhesion

(71) Applicant: Essex Group LLC, Fort Wayne, IN (US)

(72) Inventor: Allan R. Knerr, Fort Wayne, IN (US)

(21) Appl. No.: 16/775,387

(22) Filed: Jan. 29, 2020

Related U.S. Application Data
(60) Provisional application No. 62/799,070, filed on Jan. 31, 2019.

(51) Int. Cl. H01B 3/30; C09D 179/08; B32B 7/12; C08G 73/10

(52) U.S. Cl. CPC H01B 3/306; C08G 73/1042; B32B 7/12; C09D 179/08

(57) ABSTRACT

Magnet wire with improved enamel adhesion is described. The magnet wire may include a conductor and a plurality of layers of polymeric enamel insulation material formed around the conductor. One or more first or primer coats of insulation may be formed from a polyimide material that includes a dianhydride component reacted with a diamine component that includes at least eighty percent by weight of BAPP. The BAPP provides enhanced adhesion between the insulation material and the conductor. One or more second or overcoat layers of insulation may be formed over the primer coat(s). The overcoat layer(s) may be formed from a polyimide material that includes a dianhydride component reacted with a diamine component that includes ODA.

### CROSS-REFERENCE TO RELATED APPLICATION

This application claims priority to U.S. Provisional Application No. 62/799,070, filed Jan. 31, 2019 and entitled “Magnet Wire with Improved Enamel Adhesion,” the contents of which is incorporated by reference herein in its entirety.

### TECHNICAL FIELD

Embodiments of the disclosure relate generally to insulated magnet wire or winding wire and, more particularly, to insulated magnet wire in which one or more primer coats of polyimide insulation provide enhanced adhesion between the conductor and the insulation.

### BACKGROUND

Magnetic winding wire, also referred to as magnet wire or insulated winding wire, is used in a multitude of devices that require the development of electrical and/or magnetic fields to perform electromechanical work. Examples of such devices include electric motors, generators, transformers, actuator coils, etc. Typically, magnet wire is constructed by applying electrical insulation to a metallic conductor, such as a copper, aluminum, or alloy conductor. The electrical insulation is typically formed as a coating that provides for electrical integrity and prevents shorts in the magnet wire. Conventional insulation is often formed from a combination of polymeric enamel films. Typically, each enamel layer is applied as a varnish that is heat cured in an enameling oven. A plurality of layers are successively formed on one another until a desired enamel thickness or build is attained.

When enamel layers are formed on magnet wire, there is a possibility that delamination can occur. For example, an innermost enamel layer may separate from a conductor or two successive enamel layers may separate from one another. The chances of delamination may be higher for certain types of polymeric enamels, such as polyimide enamels. Accordingly, an opportunity exists for improved insulated winding wire having enhanced adhesion. In particular, an opportunity exists for improved insulated magnet wire having enhanced adhesion between a conductor and insulation formed around the conductor.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1A-1B are cross-sectional views of example magnet wire constructions that include a plurality of enamel layers, according to illustrative embodiments of the disclosure.

FIG. 2 is a flow chart of an example method for forming magnet wire, according to an illustrative embodiment.

FIG. 3 is a chart 300 depicting example adhesions for wire samples that include polyimide enamel layers formed with different weight percentages of BAPP.

FIG. 4 is a chart 400 depicting example peel strengths of rectangular wires formed with and without primer coats containing BAPP.

FIG. 5 is a chart 500 depicting example thermal indexes for wire samples containing varying numbers of primer and overcoat layers.

### DETAILED DESCRIPTION

Various embodiments of the present disclosure are directed to insulated winding wires, magnetic winding wires, and/or magnet wires (hereinafter referred to as “magnet wire”) that include a conductor with a plurality of enamel insulation layers formed around the conductor. The conductor may have any suitable cross-sectional shape, such as a round or rectangular cross-sectional shape. In certain embodiments, one or more primer, base, inner, or first layers of polymeric polyimide (“PI”) insulation may be formed directly on the conductor. In other words, no intervening layers are formed between the conductor and one or more successively formed primer or first layers. Any number of overcoat, additional, or second layers of PI insulation may then be formed over the primer layer(s). The primer layer(s) may be formed with a different PI construction than the overcoat(s) in order to enhance or improve adhesion between the conductor and the insulation system.

In certain embodiments, one or more primer coats or first layers of PI enamel may be formed by curing a polyamic acid that has been formed by reacting a dianhydride component with a diamine component that contains 2,2-bis[4-(4-aminophenoxy)phenyl] propane (“BAPP”). The diamine component of a primer coat may include any suitable percentage of BAPP as desired. Any number of overcoats or second layers of PI enamel may be formed over the primer coat(s). In certain embodiments, one or more overcoat layers may be formed by curing a polyamic acid that has been formed by reacting a dianhydride component with a diamine component that does not include or that includes relatively small amounts of BAPP. For example, the polyamic acid may be formed by reacting a dianhydride component with a diamine component containing 4,4′-oxydianiline (“ODA”).

As a result of forming one or more primer coat layers from PI that includes BAPP, adhesion between the conductor and the PI insulation may be improved or enhanced. As described in greater detail below, the adhesion of magnet wire insulation with a BAPP primer coat may be significantly higher than magnet wire with PI insulation that does not include BAPP. Further, the use of BAPP to form PI may reduce or lower the thermal index of the PI relative to PI that includes ODA. However, a desirable overall thermal index may be obtained for a magnet wire by utilizing a primer coat of PI with BAPP, and then over coating the primer coat with PI insulation that does not include BAPP or that includes relatively smaller amounts of BAPP. For example, overcoat layers of PI formed with ODA may be formed over primer coat layer(s) of PI formed with BAPP. The use of the overcoat layers may improve the overall thermal index of the magnet wire.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

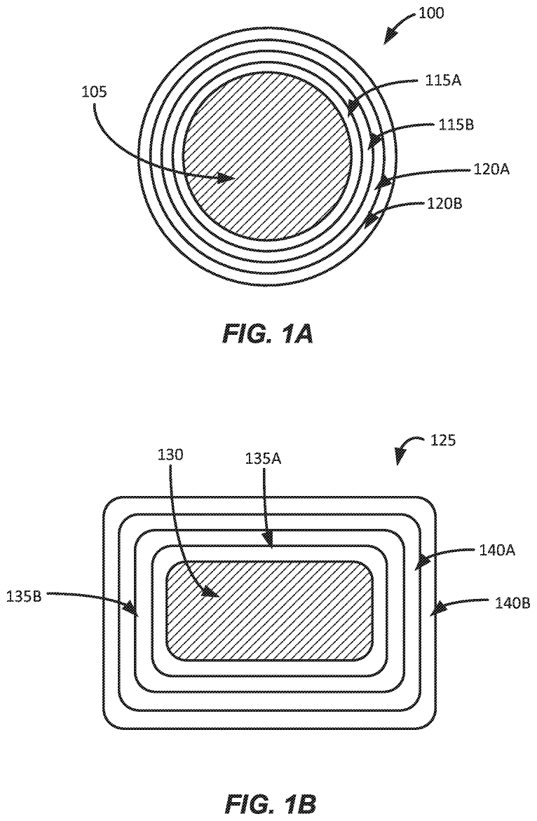

FIGS. 1A and 1B illustrate cross-sectional views of example magnet wire constructions that may be formed in accordance with various embodiments of the disclosure. FIG. 1A illustrates an example magnet wire 100 having a round or circular cross-sectional shape. FIG. 1B illustrates an example magnet wire 125 having a rectangular cross-sectional shape. Other suitable cross-sectional shapes may be utilized as desired in various embodiments, and those depicted are provided by way of non-limiting example only. Each of the example magnet wires 100, 125 may be formed with a wide variety of suitable dimensions. Additionally, as explained in greater detail below, each of the example magnet wires 100, 125 may include a respective conductor with insulation formed around the conductor.

With reference to FIG. 1A, a cross-sectional view of a first example magnet wire 100 is illustrated. The magnet wire 100 may include a central conductor 105 and a plurality of layers of insulation formed around the central conductor 105. The insulation may include one or more primer coat layers 115A, 115B or first layers of polymeric insulation material formed directly around the central conductor 105. The insulation may further include one or more overcoat layers 120A, 120B or second layers of polymeric insulation material formed around the primer coat layer(s) 115A, 115B. According to an aspect of the disclosure, the primer coat layer(s) 115A, 115B may be formed from a first polyimide (“PI”) material having a first construction or formulation while one or more of the overcoat layers 120A, 120B are formed from a second PI material having a second construction or formulation different than the first construction. Additionally, in certain embodiments, both the primer coat layers 115A, 115B and the overcoat layers 120A, 120B may be formed as polymeric enamel insulation. As desired, a wide variety of other insulation layers may optionally be formed around the conductor 105 including, but not limited to, one or more semi-conductive layers, one or more extruded layers (e.g., an extruded layer formed around an outermost enamel layer, etc.), and/or one or more conformal layers (e.g., an outermost layer formed from a parylene material, etc.).

Similarly, with reference to FIG. 1B, a second example magnet wire 125 may include a central conductor 130 and a plurality of layers of insulation formed around the central conductor 130. The insulation may include one or more primer coat layers 135A, 135B or first layers of polymeric insulation material formed directly around the central conductor 130. The insulation may further include one or more overcoat layers 140A, 140B or second layers of polymeric insulation material formed around the primer coat layer(s) 135A, 135B. According to an aspect of the disclosure, the primer coat layer(s) 135A, 135B may be formed from a first PI material having a first construction or formulation while one or more of the overcoat layers 140A, 140B are formed from a second PI material having a second construction or formulation different than the first construction. Additionally, in certain embodiments, both the primer coat layers 135A, 135B and the overcoat layers 140A, 140B may be formed as polymeric enamel insulation. As desired, a wide variety of other insulation layers may optionally be formed around the conductor 130 as described above for the first example magnet wire 100. For example, an extruded layer may be formed around an outermost enamel layer.

The first example magnet wire 100 is generally described in greater detail below; however, it will be appreciated that the description is equally applicable to the second example magnet wire 125 and/or to a wide variety of other suitable magnet wires (e.g., magnet wires having other cross-sectional shapes, etc.).

The conductor 105 may be formed from a wide variety of suitable materials or combinations of materials. For example, the conductor 105 may be formed from copper, aluminum, annealed copper, oxygen-free copper, silver-plated copper, nickel plated copper, copper clad aluminum (“CCA”), silver, gold, a conductive alloy, a bimetal, carbon nanotubes, or any other suitable electrically conductive material. Additionally, the conductor 105 may be formed with any suitable dimensions and/or cross-sectional shapes. As shown in FIG. 1A, the conductor 105 may have an approximately circular or round cross-sectional shape. However, as shown in FIG. 1B, a conductor 125 may have a rectangular or approximately rectangular cross-sectional shape. In other embodiments, a conductor may be formed with a square shape, an elliptical or oval shape, or any other suitable cross-sectional shape. Additionally, as desired for certain cross-sectional shapes such as a rectangular cross-sectional shape, a conductor may have corners that are rounded, sharp, smoothed, curved, angled, truncated, or otherwise formed.

In addition, the conductor 105 may be formed with any suitable dimensions. An example round conductor may have a diameter between approximately 0.010 inches (254 μm) and approximately 0.500 inches (12700 μm). An example rectangular conductor may have longer sides between approximately 0.020 inches (508 μm) and approximately 0.750 inches (19050 μm) and shorter sides between approximately 0.020 inches (508 μm) and approximately 0.400 inches (10160 μm). An example square conductor may have sides between approximately 0.020 inches (508 μm) and approximately 0.500 inches (12700 μm). Other suitable dimensions may be utilized as desired, and the described dimensions are provided by way of non-limiting example only.

A wide variety of suitable methods and/or techniques may be utilized to form, produce, or otherwise provide a conductor 105. In certain embodiments, a conductor 105 may be formed by drawing an input material (e.g., a larger conductor, rod stock, etc.) with one or more dies in order to reduce the size of the input material to desired dimensions. One or more flatteners and/or rollers may optionally be used to modify the cross-sectional shape of the input material before and/or after drawing the input material through any of the dies. In other embodiments, a conductor 105 may be formed via a continuous extrusion process. Other conductor formation techniques may be utilized as desired, such as additive manufacturing, etc. In certain embodiments, the conductor 105 may be formed in tandem with the application of a portion or all of the insulation system. In other words, conductor formation and application of insulation material (e.g., a plurality of enamel layers 115A, 115B, 120A, 120B, etc.) may be conducted in tandem. In other embodiments, a conductor 105 with desired dimensions may be preformed or obtained from an external source. Insulation material may then be formed around the conductor 105.

With continued reference to FIG. 1A, a plurality of layers of enamel insulation may be formed around the conductor 105. For example, one or more primer coats or first layers 115A, 115B may be formed directly around the conductor 105. One or more overcoats or second layers 120A, 120B may then be formed around the primer coat(s) 115A, 115B. An enamel layer is typically formed by applying a polymeric varnish to the conductor 105 and then baking the conductor 105 in a suitable enameling oven or furnace. The polymeric varnish typically includes polymeric material suspended in one or more solvents. Following application of the varnish, solvent is removed as a result of baking or curing, thereby leaving a solid polymeric enamel layer. Typically, a plurality of layers of enamel may be applied to the conductor 105 in order to achieve a desired enamel thickness or build. Each enamel layer may be formed utilizing a similar process. In other words, a first enamel layer may be formed, for example, by applying a suitable varnish and passing the conductor through an enameling oven. A second enamel layer may subsequently be formed by applying a suitable varnish and passing the conductor through either the same enameling oven or a different enameling oven. Indeed, an enameling oven may be configured to facilitate wires making multiple passes through the oven. As desired, other curing devices may be utilized in addition to or as an alternative to one or more enameling ovens, such as one or more suitable infrared light and/or ultraviolet light curing systems.

According to an aspect of the disclosure, the primer coat(s) 115A, 115B and at least one of the overcoats 120A, 120B may be formed from polyimide (“PI”) material. For example, the primer coat(s) 115A, 115B may be formed from a first PI material that exhibits or provides increased adhesion of the insulation to the conductor 105. At least one of the overcoats 120A, 120B may then be formed from a second PI material different than the first PI material, such as a second PI material that has desirable thermal properties. A PI enamel layer is typically formed by curing a polyamic acid suspended in solvent (e.g., curing a varnish with polyamic acid in an enameling oven, etc.). A polyamic acid is typically formed by reacting one or more dianhydride components with equivalent amounts of one or more diamine components.

Any number of primer coats 115A, 115B or first layers of enamel may be formed on the conductor 105 as desired in various embodiments. For example, one or two layers of enamel may be formed on the conductor as primer coats 115A, 115B. In various embodiments, one, two, three, four, or five primer coats may be formed, a number of primer coats may be incorporated into a range between any two of the above values, or a number of primer coats may be incorporated into a range bounded on a minimum or maximum end by one of the above values.

According to an aspect of the disclosure, one or more primer coat(s) 115A, 115B may be formed by curing a polyamic acid that has been formed by reacting a dianhydride component with a diamine component that contains 2,2-bis[4-(4-aminophenoxy)phenyl] propane (“BAPP”). A wide variety of suitable dianhydride components may be utilized as desired, such as pyromellitic dianhydride (“PMDA”). In certain embodiments, the dianhydride and diamine components may be reacted in a nearly equal ratio (e.g., in nearly equivalent amounts) in order to form the polyamic acid. The polyamic acid may then be applied to the conductor 105 and cured (e.g., cured in an enameling oven, etc.) in order to form a PI primer coat (generally referred to as primer coat 115).

The diamine component utilized for a primer coat 115 may be formed with any suitable percentage of BAPP as desired. For example, the diamine component may be formed substantially (e.g., approximately 100% by weight) from BAPP. As another example, the diamine component may be formed by mixing or blending BAPP with one or more other materials. In certain embodiments, the BAPP may constitute at least eighty percent by weight of the diamine component. For example, in various embodiments, the diamine component may include approximately 80, 85, 90, 95, 98, 99, or 100% by weight of BAPP, a weight percentage of BAPP included in a range between any two of the above values (e.g., between 80% and 100% by weight of BAPP, etc.), or a weight percentage of BAPP included in a range bounded on a minimum end by one of the above values (e.g., at least 80, 90, 95, or 99% by weight of BAPP, etc.).

A blended or mixed diamine component may include a wide variety of other ingredients combined with BAPP. For example, BAPP may be blended or mixed with 4,4′-oxydianiline (“ODA”) and/or other suitable ingredient components. In certain example embodiments, a blended diamine component may include between approximately 80.0% and approximately 99.0% by weight of BAPP, and between 1.0% and 20% by weight of ODA. A wide variety of other suitable blending ratios may be utilized as desired (e.g., between approximately 90.0% and approximately 99.0% by weight of BAPP, and between 1.0% and 10.0% by weight of ODA, etc.).

In certain embodiments, a plurality of primer coats 115A, 115B may be formed with the same construction. In other embodiments, at least two of a plurality of primer coats 115A, 115B may be formed with different constructions. For example, two primer coats 115A, 115B may be formed with different weight percentages of BAPP. In certain embodiments, a first primer coat 115A may have a higher weight percentage of BAPP than a second primer coat 115B formed on the first primer coat 115A. In other embodiments, a weight percentage of BAPP may be gradually reduced through a plurality of primer coats as the primer coats are formed around the conductor 105.

As a result of forming one or more primer coat layers 115A, 115B from PI that includes BAPP, adhesion between the conductor 105 and the insulation may be improved or enhanced. As discussed in greater detail below, the adhesion of magnet wire insulation with a BAPP primer coat may be significantly higher than magnet wire with PI insulation that does not include any BAPP.

Any number of overcoats 120A, 120B or second layers of enamel may be formed over the primer coat(s) 115A, 115B as desired in various embodiments. For example, 1, 2, 3, 4, 5, 6, 7, 8, 10, 12, 15, 17, 18, 20, 22, 24, 25, 26, or 28 layers, a number of layers included in a range between any two of the above values, or a number of layers included in a range bounded on a minimum end by one of the above values may be formed as overcoat insulation. According to an aspect of the disclosure, at least one overcoat layer (e.g., at least an innermost overcoat layer 120A formed directly over the primer coat(s) 115A, 115B) may be formed from a second PI material different than a first PI material (or combination of first PI materials if differing amounts of BAPP are incorporated into different primer coat layers) utilized to form the primer coat(s) 115A, 115B.

An overcoat layer (generally referred to as overcoat layer 120) may be formed by curing a polyamic acid that has been formed by reacting a dianhydride component with a diamine component that does not include or that includes relatively small amounts of BAPP. For example, the polyamic acid may be formed by reacting a dianhydride component (e.g., PMDA, etc.) with a diamine component containing ODA. The diamine component may include any suitable weight percentage of ODA, such as 50, 55, 60, 70, 75, 80, 85, 90, 95, 98, 99, or 100% by weight of ODA, a weight percentage of ODA included in a range between any two of the above values (e.g., between 50 and 100% by weight of ODA, etc.), or a weight percentage of ODA included in a range bounded on a minimum end by one of the above values (e.g., at least 50, 60, 75, 85, 90, 95, or 99% by weight of ODA, etc.). In certain embodiments, the dianhydride and diamine components may be reacted in an equivalent ratio in order to form the polyamic acid used for an overcoat layer 120. The polyamic acid may then be applied over a topmost primer coat layer (or a subsequently applied overcoat layer) and cured (e.g., cured in an enameling oven, etc.) in order to form a PI overcoat layer 120.

As set forth above, the use of BAPP to form one or more PI primer coats 115A, 115B may enhance adhesion between the conductor 105 and the insulation. However, the incorporation of BAPP into PI may reduce or lower the thermal index of the PI relative to PI formed without BAPP (e.g., PI formed with ODA, etc.). However, a desirable overall thermal index may be obtained for a magnet wire 100 by utilizing one or more primer coats of PI with BAPP 115A, 115B, and then over coating the primer coat(s) 115A, 115B with PI insulation that does not include BAPP or that includes relatively smaller amounts of BAPP. For example, overcoat layers of PI formed with ODA 120A, 120B may be formed over primer coat layer(s) of PI formed with BAPP 115A, 115B. The use of the overcoat layers 120A, 120B may provide a desired overall thermal index of the magnet wire insulation and/or mask the thermal deficiencies of the primer coat layer(s) 115A, 115B.

Any number of enamel layers may be formed as desired in various embodiments. Although two PI overcoat enamel layers 115A, 115B are illustrated in FIG. 1A, a wide variety of additional types of enamel may be incorporated into a magnet wire 100 as desired in various embodiments. For example, the overcoat layers 120A, 120B may include a combination of one or more PI layers and one or more additional enamel layers formed from other materials. As another example, one or more additional enamel layers formed from other materials may be formed over the overcoat layers 120A, 120B. As yet another example, one or more overcoat layers 120A, 120B and/or additional enamel layers may be formed by blending or mixing PI with one or more other materials.

In addition to PI, a wide variety of other suitable polymeric materials may be utilized as desired to form an enamel layer. Examples of suitable materials include, but are not limited to, polyamideimide, amideimide, polyester, polyesterimide, polysulfone, polyphenylenesulfone, polysulfide, polyphenylenesulfide, polyetherimide, polyamide, polyketones, etc. As desired, enamel materials may be selected to have a suitable National Electrical Manufacturers Association (“NEMA”) thermal class or thermal rating, such as a rating of A, B, F, H, N, R, S, or higher. Higher temperature enamel materials may having a NEMA thermal class rating of R, S, or higher. Additionally, in certain embodiments, an enamel layer may be formed as a mixture of two or more materials. Further, in certain embodiments, different enamel layers may be formed from the same material(s) or from different materials. For example, a first enamel layer (e.g., an overcoat layer 120A) may be formed from a polyimide material and a second enamel layer (e.g., an additional enamel layer) may be formed from a polyamideimide material. A wide variety of suitable combinations of different types of polymeric materials may be utilized to form any desired number of enamel layers.

Regardless of the material(s) utilized to form an enamel layer (e.g., PI, etc.), in certain embodiments, enamels may include polymeric materials that are thermoset materials rather than thermoplastic materials. For purposes of this disclosure, a thermoset material may be a material that is generally non-meltable. A thermoset material may degrade or decompose before it melts, thereby preventing the material from being melted and reformed. As a result, thermoset materials are typically applied in a varnish and subsequently cured in order to form polymeric insulation. By contrast, a thermoplastic material may typically be melted and reformed without degradation or deterioration and, therefore, is typically applied via extrusion.

Additionally, each layer of enamel and/or a total enamel build may have any desired thickness, such as a thickness of approximately 0.0002, 0.0005, 0.007, 0.001, 0.002, 0.003, 0.004, 0.005, 0.006, 0.007, 0.008, 0.009, 0.010, 0.012, 0.015, 0.017, or 0.020 inches, a thickness included in a range between any two of the aforementioned values, and/or a thickness included in a range bounded on either a minimum or maximum end by one of the aforementioned values. The one or more primer coats 115A, 115B may also form a wide variety of suitable percentages of an overall enamel or insulation thickness or build, such as an overall build or thickness of the combined primer coat(s) 115A, 115B and overcoat(s) 120A, 120B. In certain embodiments, the one or more primer coats 115A, 115B may form between approximately 3.0 percent and approximately 25 percent of an overall enamel build. For example, if two primer coat layers and eight overcoat layers are formed with similar thickness, then the primer coat layers may constitute approximately twenty percent of the total build. As another example, if two primer coat layers and 38 overcoat layers are formed with similar thicknesses, then the primer coat layers may constitute approximately five percent of the total build. In various embodiments the one or more primer coats 115A, 115B may form or constitute approximately 3, 4, 5, 7, 8, 10, 12, 15, 17, 18, 20, 22, or 25 percent of a total enamel thickness and/or build, a percentage included in a range bounded by any two of the above values, or a percentage included in a range bounded on either a minimum or maximum end by one of the above values.

In certain embodiments, one or more suitable filler materials and/or additives may be incorporated into one or more enamel layers. Examples of suitable filler materials include, but are not limited to, inorganic materials such as metals, transition metals, lanthanides, actinides, metal oxides, and/or hydrated oxides of suitable materials such as aluminum, tin, boron, germanium, gallium, lead, silicon, titanium, chromium, zinc, yttrium, vanadium, zirconium, nickel, etc.; suitable organic materials such as polyaniline, polyacetylene, polyphenylene, polypyrrole, other electrically conductive particles; and/or any suitable combination of materials. The filler material(s) may enhance the corona resistance of the enamel and/or the overall insulation system. In certain embodiments, the filler material(s) may also enhance one or more thermal properties of the enamel and/or overall insulation system, such as temperature resistance, cut-through resistance, and/or heat shock. The particles of a filler material may have any suitable dimensions, such as any suitable diameters. In certain embodiments, a filler material may include nanoparticles. Further, any suitable blend or mixture ratio between filler material and enamel base material may be utilized.

In certain embodiments, at least one enamel layer may have an outer surface that is modified by a plasma, corona, flame, ultraviolet (“UV”) or other suitable treatment in order to promote adhesion between the enamel layer and a layer formed on top of the enamel layer and/or to enhance the wettability of a varnish used to form a layer on top of the enamel layer. Similarly, an outer surface of the conductor 105 may be modified by a suitable treatment in order to promote adhesion between the conductor 105 and a first enamel layer (e.g., a first primer coat layer 115A) and/or to enhance the wettability of a varnish used to form the first enamel layer. A suitable surface treatment may facilitate a stronger bond and/or improved adhesion between layers, thereby reducing the possibility of delamination. Additionally, a surface modification may alter the surface energy of a modified layer, thereby allowing the varnish used to form a subsequent layer to more evenly spread along a surface of the modified layer. In other words, pooling of the varnish on the surface of the modified layer may be reduced as a result of the surface modification. Improved wettability and/or varnish flow during the formation of an enamel layer may assist in improving the concentricity of the formed enamel layer.

As desired in various embodiments, one or more other layers of insulation may be incorporated into a magnet wire 100 in addition to a plurality of enamel layers (e.g., the primer coat layer(s) 115A, 115B and the overcoat enamel layer(s) 120A, 120B). In certain embodiments, the overcoat layers may include a combination of enamel layer(s) and layers of other types of insulation. In other embodiments, additional layers of other types of insulation may be formed over the overcoat enamel layer(s). A wide variety of other types of insulation (e.g., non-enamel insulation) may be utilized as desired. For example, one or more extruded thermoplastic layers, semi-conductive layers, tape insulation layers, and/or conformal coatings may be incorporated into a magnet wire 100. Indeed, an overall insulation system may include any number of suitable sublayers formed from any suitable materials and/or combinations of materials. A few example types of insulation that may be combined with enamel layers are described in greater detail below.

As one example, one or more suitable insulating wraps or tapes, such as a polymeric tape, may be wrapped around a plurality of enamel layers and/or other underlying insulation layers. A tape may include a wide variety of suitable dimensions, such as any suitable thickness and/or width. Additionally, a tape may be wrapped around the conductor 105 at an angle along a longitudinal direction or length of the conductor 105.

As another example, one or more layers of extruded material, such as layers formed from one or more suitable thermoplastic resins, may be incorporated into an insulation system. A wide variety of suitable materials may be incorporated into a resin or a plurality of resins utilized to form extruded layers. Examples of suitable materials include, but are not limited to, polyether-ether-ketone (“PEEK”), polyaryletherketone (“PAEK”), other suitable materials that includes at least one ketone group, thermoplastic polyimide (“PI”), aromatic polyamide, aromatic polyester, polyphenylene sulfide (“PPS”), materials that combine one or more fluoropolymers with base materials (e.g., materials that include at least one ketone group, etc.), other suitable thermoplastic materials, etc. If a plurality of layers is utilized, the extruded layers may be formed from the same material or, alternatively, at least two layers may be formed from different materials. An extruded layer may also be formed with any suitable thickness as desired in various embodiments. An extruded layer may be formed directly on an underlying layer (e.g., an outermost enamel layer, etc.) or, alternatively, one or more suitable bonding agents, adhesion promoters, or adhesive layers may be incorporated between the extruded layer and an underlying layer. In certain embodiments, the extruded layer may be formed to have a cross-sectional shape similar to that of the underlying conductor and/or any underlying insulation layers. In other embodiments, an extruded layer may be formed with a cross-sectional shape that varies from that of the underlying conductor. As one non-limiting example, the conductor may be formed with an elliptical cross-sectional shape while an extruded layer is formed with an approximately rectangular cross-sectional shape.

As another example, one or more semi-conductive layers may be incorporated into the magnet wire 100. For example, one or more semi-conductive layers may be incorporated into a plurality of enamel layers. A semi-conductive layer may have a conductivity between that of a conductor and that of an insulator. Typically, a semi-conductive layer has a volume conductivity (a) between approximately 10⁻⁸ Siemens per centimeter (S/cm) and approximately 10³ S/cm at approximately 20 degrees Celsius (° C.). In various embodiments, one or more suitable semi-conductive enamels, extruded semi-conductive materials, semi-conductive tapes, and/or semi-conductive wraps may be utilized. In certain embodiments, a semi-conductive layer may be formed from a material that combines one or more suitable filler materials (e.g., semi-conductor and/or conductive fillers, etc.) with one or more base materials. Examples of suitable filler materials include, but are not limited to, suitable inorganic materials such as metallic materials and/or metal oxides (e.g., zinc, copper, aluminum, nickel, tin oxide, chromium, potassium titanate, etc.), and/or carbon black; suitable organic materials such as polyaniline, polyacetylene, polyphenylene, polypyrrole, other electrically conductive particles; and/or any suitable combination of materials. The particles of the filler material may have any suitable dimensions, such as any suitable diameters. In certain embodiments, the filler material may include nanoparticles. Examples of suitable base materials include, but are not limited to, polyimide, polyamideimide, amideimide, polyester, polyesterimide, polysulfone, polyphenylenesulfone, polysulfide, polyphenylenesulfide, polyetherimide, polyamide, or any other suitably stable high temperature material. Any suitable blend or mixture ratio between filler material and base material may be utilized. Additionally, a semi-conductive layer may have any suitable thickness, such as a thickness similar to those discussed above for enamel layers. As a result of incorporating one or more semi-conductive layers, non-uniform electric, magnetic, and/or electromagnetic fields (hereinafter collectively referred to as electric fields) may be equalized or “smoothed out”, thereby reducing local stress in the insulation and improving electrical performance. In other words, one or more semi-conductive layers may assist in equalizing voltage stresses in the insulation and/or dissipating corona discharges.

Regardless of the number and/or types of insulation layers formed on a magnet wire 100, the insulation (and/or any sublayers) may be formed with any desired concentricity. In certain embodiments the insulation and/or any sublayer may be formed with a concentricity less than or equal to approximately 1.1, 1.2, 1.3, 1.4, 1.5, or any other suitable value. Additionally, regardless of the number of sublayers incorporated into the insulation, the insulation may have any desired overall thickness. As desired, the insulation may be formed from one or more layers that have any number of desirable properties, such as desired PDIV, dielectric strength, dielectric constant, and/or thermal rating values.

In certain embodiments, one or more conformal layers may be formed as outermost layers of a magnet wire 100. For example, one or more layers containing parylene (or another suitable conformal material) may be formed around the conductor 105 and any other insulation layers, such as the plurality of enamel layers. As desired, an adhesion promotor may optionally be applied to an underlying layer prior to the formation of a conformal layer. As desired, an underlying layer may be subjected to a plasma or similar treatment prior to formation of a conformal layer. Each conformal coating may consist of a relatively thin polymeric film that conforms to the contours of an underlying winding or magnet wire, article formed from a magnet wire, or an appliance incorporating a magnet wire. Additionally, a conformal coating may be applied utilizing a wide variety of techniques. For example, a conformal coating may be applied via one or more suitable chemical vapor deposition techniques. In other embodiments, a conformal coating may be applied via brushing, dipping, spraying, and/or other suitable methods. Examples of suitable materials utilized to form conformal coatings include, but are not limited to, one or more parylene materials, one or more acrylic materials, one or more epoxy materials, polyurethane, silicones, polyimides, fluoropolymers, etc. A conformal layer may be formed with a wide variety of suitable thicknesses. In certain embodiments, a conformal layer may be formed with a thickness between approximately one micron (1 μm) and approximately 40 μm.

The magnet wires 100, 125 described above with reference to FIGS. 1A and 1B are provided by way of example only. A wide variety of alternatives could be made to the illustrated magnet wires 100, 125 as desired in various embodiments. For example, a wide variety of different types of insulation layers may be incorporated into a magnet wire 100, 125 in addition to a plurality of enamel layers. As another example, the cross-sectional shape of a magnet wire 100, 125 and/or one or more insulation layers may be altered. Indeed, the present disclosure envisions a wide variety of suitable magnet wire constructions. These constructions may include insulation systems with any number of layers and/or sublayers.

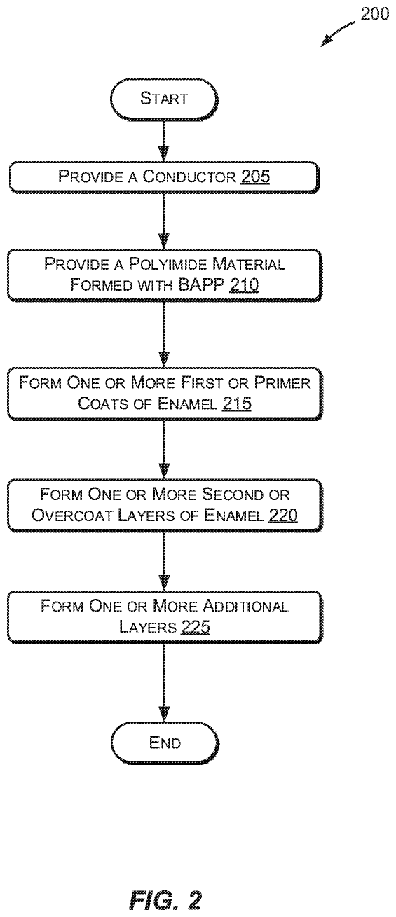

FIG. 2 illustrates a flow chart of an example method 200 for forming magnet wire in accordance with an illustrative embodiment of the disclosure. The method 200 may begin at block 205. At block 205, a magnet wire conductor may be provided in accordance with a wide variety of suitable techniques and/or utilizing a wide variety of suitable wire formation systems. For example, a conductor may be drawn from a suitable input material (e.g., a larger diameter conductor, rod stock, etc.). In certain embodiments, a wire forming device may include one or more dies through which the input material is drawn in order to reduce the size of the input material to desired dimensions. Additionally, in certain embodiments, one or more flatteners and/or rollers may be used to modify the cross-sectional shape of the input material before and/or after drawing the input material through any of the dies. For example, rollers may be used to flatten one or more sides of input material in order to form a rectangular or square wire. As another example, a conductor may be provided via a suitable continuous extrusion or conform machine. For example, a conform machine may receive rod stock (or other suitable input material) from a payoff or other source, and the conform machine may process and/or manipulate the rod stock to produce a desired conductor via extrusion. As yet another example, a preformed conductor may be provided or received from a suitable payoff or source. In other words, a conductor may be preformed in an offline process or obtained from a supplier.

At block 205, a polymeric PI material that is formed with BAPP may be provided. For example, a PI material that is formed by reacting a dianhydride component in equivalent ratio with a diamine component that includes BAPP may be provided. The PI material may then be utilized at block 215 to form one or more first or primer coats of enamel on the conductor. For example, the PI material may be applied to the conductor and then cured in order to form a primer coat, and the process may be repeated until a desired number of primer coats have been formed. As discussed above, in certain embodiments, the same PI material may be utilized to form a plurality of primer coats. In other embodiments, different PI materials (e.g., materials containing different amounts or weight percentages of BAPP, etc.) may be utilized to form different primer coat layers.

At block 220, one or more second or overcoat layers may be formed over the primer coat layer(s). In certain embodiments, the overcoat layer(s) may include at least one layer formed from a second polymeric PI material that either does not include BAPP or includes a limited amount of BAPP. For example, one or more overcoat layers may be formed from a polymeric PI material formed by reacting a dianhydride component in equivalent ratio with a diamine component that includes ODA (or a desired weight percentage of ODA). Any number of overcoat layers may be formed as desired. Additionally, the use of BAPP in the primer coat(s) may facilitate enhanced adhesion between the conductor and the insulation formed around the conductor.

At block 225, which may be optional in certain embodiments, one or more additional layers may be formed around the overcoat layer(s). A wide variety of different types of additional layers may be formed including, but not limited to, one or more layers of extruded thermoplastic material, one or more semi-conductive layers, one or more tape or wrap layers, and/or one or more conformal coatings. Any number of suitable devices, such as extrusion devices and/or vapor deposition chambers, may be configured to form additional layers. The method may end following block 225.

The operations described and shown in the method 200 of FIG. 2 may be carried out or performed in any suitable order as desired in various embodiments. Additionally, in certain embodiments, at least a portion of the operations may be carried out in parallel. Furthermore, in certain embodiments, less than or more than the operations described in FIG. 2 may be performed.

As set forth above, the formation of one or more PI primer coat layers from a material that includes BAPP may enhance or improve adhesion between a magnet wire conductor and insulation. A wide variety of suitable test methods may be utilized to determine and illustrate the improved adhesion relative to conventional PI that does not include BAPP. Examples of suitable test methods include, but are not limited to, a Slit Twist Adhesion test (“STA test”), a Slit, Twist, and Peel test (“STP test”), and/or an Instron peel test. Each of these example tests is described in greater detail below with reference to example round and rectangular wire samples.

An STA measures an insulation film's adherence to an underlying conductor. The test is typically suitable for round wire conductors that are between 12 and 28 American Wire Gauge (“AWG”). Conductor sizes smaller than 28 AWG tend to break before the film loses adhesion with the conductor. An STA Test System may be a motorized specimen twister that twists a single wire sample or specimen with a scrape along its axial length until the insulation peels from the conductor. A turn counter determines the number of rotations required until the insulation peels from the conductor. The test measures the number of 360 degree twists of the wire sample required. Similarly, a STP test measures an insulation film's adherence to an underlying conductor. An STP Test System may be a motorized specimen twister that twists a single wire sample or specimen with a scrape along the axial length until the insulation peels from the conductor. A turn counter determines the number of rotations required. The STP Test System is designed to be modular, ergonomic and user friendly. One example STP Test System that may be utilized is a Nova 1590 system. The STP Test System may be utilized to test a wide variety of round wire sizes, such as sizes ranging between 12 AWG and 44 AWG (e.g., approximately 0.05 mm to approximately 2.05 mm in diameter).

Several wire samples were prepared and tested in order to compare the adhesion of PI insulation formed with an ODA diamine to PI insulation that includes a primer coat formed with various amounts of BAPP. A first trial involved the formation of round wire samples with triple build insulation. Different weight percentages of BAPP were utilized as diamine components that were reacted with PMDA as a dianhydride component in order to form samples. An STP test was then performed on the samples in order to determine adhesion of the PI insulation to the conductor.

Similarly, a second trial involved the formation of wire samples with heavy build insulation (e.g., thicker enamel insulation than triple build). Different weight percentages of BAPP were utilized as diamine components that were reacted with PMDA as a dianhydride component in order to form various round wire samples with PI insulation. An STP test was then performed on the samples in order to determine adhesion of the PI insulation to the conductor. The results of the testing for the two trials is set forth in Table 1 below:

TABLE 1
Improvement of STP with a BAPP Diamine

| | | | |
|---|---|---|---|
| | Diamine | | |
| | (ODA/BAPP | Weight % of | |
| Dianhydride | equivalent ratio) | BAPP | STP |

First Trial - Triple Build

| | | | |
|---|---|---|---|
| PMDA | 100/0 | 0.0% | 34 |
| PMDA | 50/50 | 67.2% | 69 |
| PMDA | 25/75 | 86.0% | 73 |
| PMDA | 0/100 | 100.0% | 138 |

Second Trial - Heavy Build

| | | | |
|---|---|---|---|
| PMDA | 100/0 | 0.0% | 43 |
| PMDA | 75/25 | 40.6% | 65 |
| PMDA | 50/50 | 67.2% | 64 |
| PMDA | 25/75 | 86.0% | 62 |
| PMDA | 0/100 | 100.0% | 181 |

The weight percentages expressed in Table 1 above were calculated based upon ODA having an equivalent weight of 100.12 and BAPP having an equivalent weight of 205.26. For an example blend of ODA and BAPP at a 50/50 (or 1 to 1) equivalent ratio, the weight percentage of the BAPP is calculated as the weight of BAPP divided by the total weight of ODA and BAPP or (205.26 divided by (100.12+205.226)), which results in 67.2%.

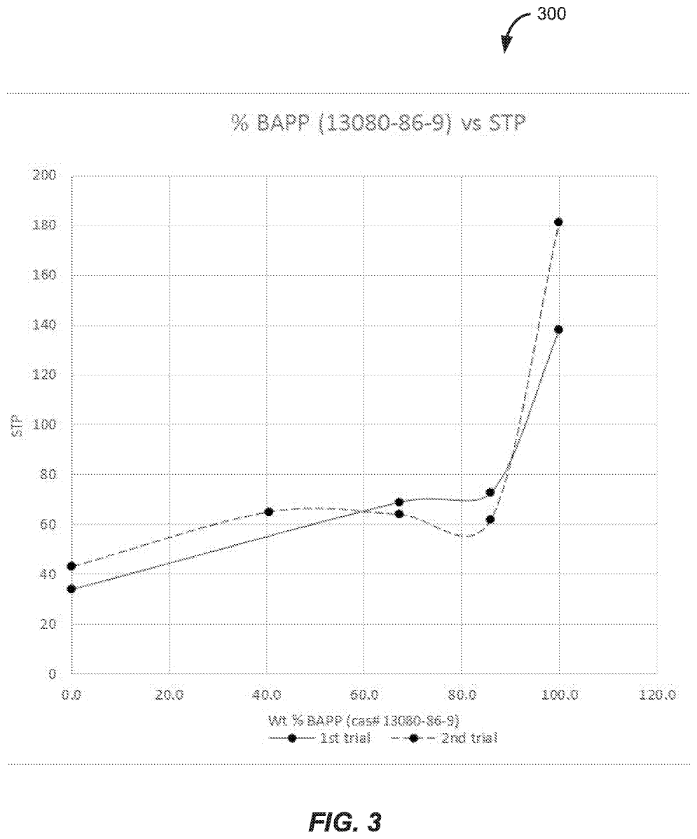

As shown in Table 1, the formation of a PI insulation layer (e.g., a PI primer coat) utilizing higher amounts of BAPP drastically improves adhesion of the insulation with the conductor. In particular, a PI primer coat that includes at least 80% by weight of BAPP as a diamine component was shown to exhibit enhanced adhesion over traditional PI insulation that utilizes ODA as a diamine component. In various embodiments, a PI primer coat may be formed with any suitable amount of BAPP as a diamine component, such as at least 80, 85, 90, 95, 98, or 99 percent by weight of BAPP as a diamine component. In certain embodiments, the diamine component utilized to form a PI primer coat may be substantially all BAPP (e.g., approximately 100%). A graphical representation of the data set forth in Table 1 is set forth in FIG. 3, which includes a graph 300 depicting the relationship between BAPP in a PI layer and adhesion as measured via an STP test. As shown in FIG. 3, enhanced adhesion may be obtained when the diamine component utilized to form PI primer coat layer exceeds 80% by weight of BAPP.

While STP and STA testing is suitable for evaluating round wire samples, an insulation peel test is a suitable test method for evaluating adhesion of insulation formed on rectangular wire samples. An example test system that may be utilized to form an insulation peel test is an Instron Peel Test system. For the peel strength test, two slits are made through the enamel along a length of a rectangular wire sample. The wire sample is then cut in a transverse direction to the slits. The slits are formed such that a desired strip, such as a 1.44 mm wide strip of enamel, can be accessed on a surface of the wire sample. An Instron peel testing machine is then utilized to measure the force required to peel the insulation away from the wire sample.

Rectangular wire samples were prepared in order to evaluate the adhesive properties of insulation that includes a PI primer coat formed from a polyamic acid having a BAPP diamine component. As desired, any number of overcoat layers may be formed on top of a primer coat layer. An insulation peel test was performed on the rectangular wire samples in order to evaluate adhesive properties of magnet wire that includes a PI primer coat formed by reacting PMDA with BAPP. In particular, wire samples that include PI insulation with no primer coat (i.e., PI insulation formed from reacting PMDA with ODA) were compared to wire samples that include a primer coat with BAPP (i.e., PI insulation formed from reacting PMDA with BAPP as a diamine at a one hundred percent weight percentage). The results of the peel testing performed on rectangular wire samples is set forth in Table 2 below:

TABLE 2
Peel Test Evaluating BAPP Primer Coat Adhesion
Rectangular Adhesion Test: Instron Peel Test

| Enamel | Primer Coat | Peel Strength (N/mm) |
|---|---|---|
| PI | None | <0.1-0.97 |
| PI | PMDA/BAPP | 1.56-2.05 |

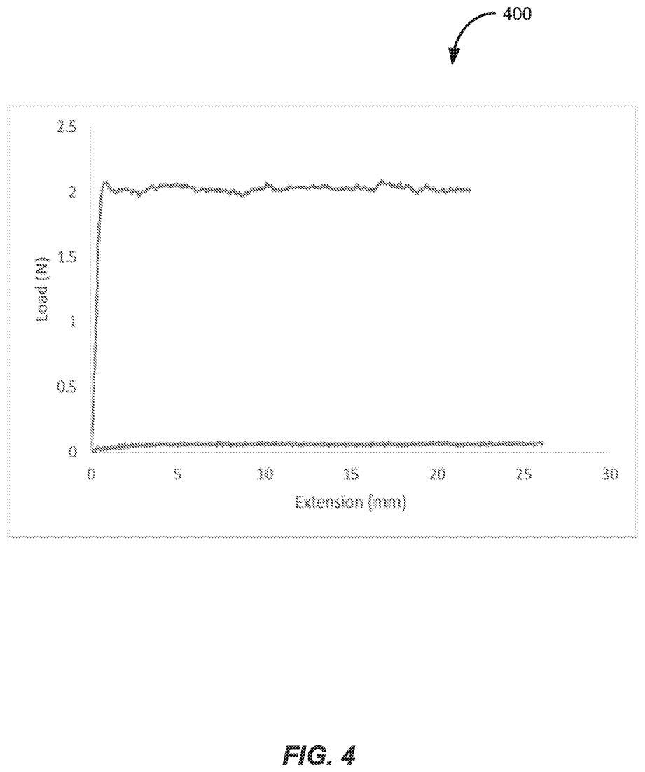

A graphical representation of the measured peel strengths is set forth in FIG. 4, which includes a graph 400 depicting the measured peel strengths of wire samples formed both with and without primer coats containing BAPP. As shown, significantly enhanced adhesion between the conductor and the insulation system may be attained by forming a primer coat that includes a BAPP diamine component.

As a result of forming PI by reacting a dianhydride component (e.g., PMDA) with BAPP as a diamine component, a thermal index of the PI may be lower than that of PI formed with ODA as a diamine component. Wire samples having PI insulation formed with varying amounts of BAPP used as a diamine component were prepared, and thermal index testing was performed on the samples. Although thermal index testing typically requires greater than 5000 hours of continuous testing, approximate thermal indexes were determined for samples of wire that include various numbers and ratios of PMDA-BAPP polymer layers and PMDA-ODA polymer layers. A number of PMDA-BAPP layers ranged from 0.0% to 100.0% of a total number of 12 layers within the various samples. These approximated thermal indexes are set forth in Table 3 below:

TABLE 3
Thermal Index of PI with BAPP
Thermal Index of PI with BAPP

| Layers of BAPP Polymer + | % of BAPP Layers | Thermal Index |
|---|---|---|
| Layers of ODA Polymer | (% of Thickness) | (° C.) |
| 12 + 0 | 100.0% | 176 |
| 10 + 2 | 83.3% | 226 |
| 8 + 4 | 66.7% | 232 |
| 4 + 8 | 33.3% | 239 |
| 2 + 10 | 16.7% | 234 |
| 0 + 12 | 0.0% | 254 |

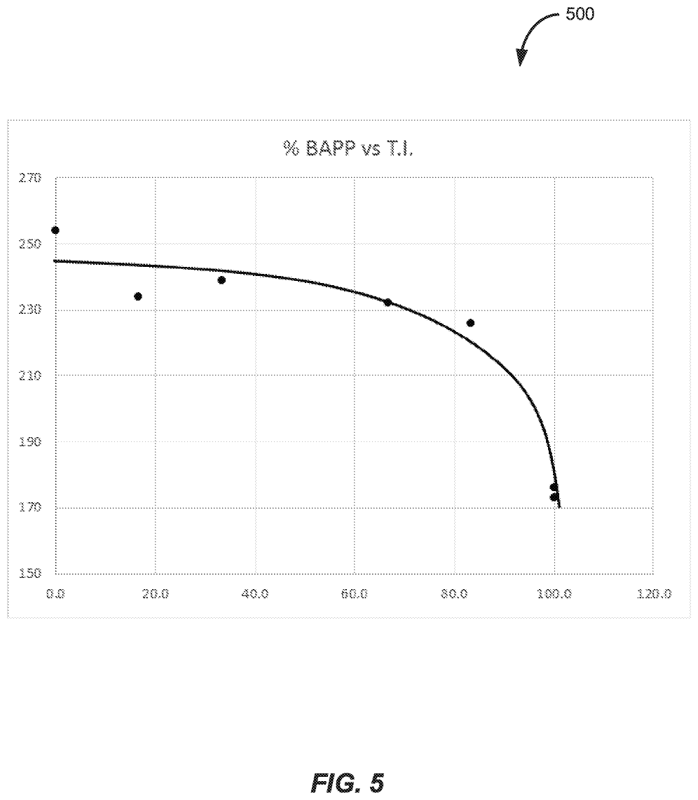

A graphical representation of the determined thermal index ratings set forth in Table 3 is depicted in FIG. 5, which includes a chart 500 depicting the thermal index ratings of wire samples formed with different numbers of primer and/or overcoat layers. As illustrated in Table 3 and FIG. 5, increased amounts of BAPP diamine component lower the thermal index of resulting PI insulation. However, an overall desired thermal index of an insulation system may be attained by utilizing BAPP in one or more primer coats formed directly on a conductor. One or more additional layers of PI insulation that are formed from polyamic acids that either do not include BAPP or that include relatively small amounts of BAPP may then be formed over the primer coats. For example, between one and twenty-eight PI overcoats formed from a polyamic acid that utilizes ODA as a diamine component may be formed over the primer coat(s). The overcoat(s) have a higher thermal index due to reduced use of BAPP or elimination of BAPP. Further, the higher thermal index of the overcoat(s) raises the thermal index of the overall insulation system to acceptable or desirable levels.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A magnet wire comprising:
a conductor;
a layer of first polyimide insulation formed directed on the conductor, the first polyimide insulation comprising a first dianhydride component reacted in equivalent ratio with a first diamine component, the first diamine component comprising at least eighty percent by weight of 2,2-bis[4-(4-aminophenoxy)phenyl] propane (BAPP); and
at least one layer of second polyimide insulation formed around the first polyimide insulation, the second polyimide insulation comprising a second dianhydride component reacted in equivalent ratio with a second diamine component, the second diamine component comprising at least fifty percent by weight of 4,4′-oxydianiline (ODA).

2. The magnet wire of claim 1, wherein the first diamine component comprises at least ninety-five percent by weight of BAPP.

3. The magnet wire of claim 1, wherein the first diamine component comprises a mixture of BAPP and ODA.

4. The magnet wire of claim 3, wherein the first diamine component comprises between 80% and 99% by weight of BAPP and between 1% and 20% by weight of ODA.

5. The magnet wire of claim 1, wherein the second diamine component comprises at least ninety-five percent by weight of ODA.

6. The magnet wire of claim 1, wherein the first polyimide insulation comprises a plurality of layers of first polyimide insulation.

7. The magnet wire of claim 1, wherein the first polyimide insulation comprises either one or two layers of first polyimide insulation.

8. The magnet wire of claim 1, wherein the second polyimide insulation comprises between one and twenty-eight layers of second polyimide insulation.

9. The magnet wire of claim 1, wherein a thickness of the first polyimide insulation comprises between three and twenty-five percent of a combined thickness of the first polyimide insulation and the second polyimide insulation.

10. The magnet wire of claim 1, wherein the conductor comprises copper.

11. A magnet wire comprising:
a conductor;
a primer coat of first polymeric enamel insulation formed directly on the conductor, the primer coat comprising a first polyimide material formed by reacting a first dianhydride component with a first diamine component, the first diamine component comprising 2,2-bis[4-(4-aminophenoxy)phenyl] propane (BAPP);
an overcoat of second polymeric enamel insulation formed around the primer coat, the overcoat comprising a second polyimide material formed by reacting a second dianhydride component with a second diamine component, the second diamine component comprising 4,4′-oxydianiline (ODA).

12. The magnet wire of claim 11, wherein the first diamine component comprises at least eighty percent by weight of BAPP.

13. The magnet wire of claim 11, wherein the first diamine component comprises at least ninety-five percent by weight of BAPP.

14. The magnet wire of claim 11, wherein the first diamine component comprises a mixture of BAPP and ODA.

15. The magnet wire of claim 14, wherein the first diamine component comprises between 80% and 99% by weight of BAPP and between 1% and 20% by weight of ODA.

16. The magnet wire of claim 11, wherein the second diamine component comprises at least ninety-five percent by weight of ODA.

17. The magnet wire of claim 11, wherein the primer coat comprises a plurality of layers of the first polyimide insulation material.

18. The magnet wire of claim 11, wherein the primer coat comprises either one or two layers of the first polyimide insulation material.

19. The magnet wire of claim 11, wherein the overcoat comprises between one and twenty-eight layers of the second polyimide insulation material.

20. The magnet wire of claim 11, wherein a thickness of the primer coat comprises between three and twenty-five percent of a combined thickness of the primer coat and the overcoat.
